(19) United States
(12) Patent Application Publication
(10) Pub. No.: US 2006/0229746 A1
(43) Pub. Date: Oct. 12, 2006

(54) Modular controller for an environmental management system

(76) Inventors: Jeffrey D. Ollis, Dresher, PA (US); John M. Coogan, Lansdale, PA (US); James A. Panacek, North Wales, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/254,422

(22) Filed: Oct. 20, 2005

Related U.S. Application Data
(60) Provisional application No. 60/669,101, filed on Apr. 7, 2005.

(51) Int. Cl. G05B 11/01; G05B 19/18

(52) U.S. Cl. 700/65; 700/66; 700/19

(57) ABSTRACT

A controller is provided for an environmental management system. The system includes a transceiver for transmitting signals to and receiving signals from at least one environmental sensor or actuator over a network and a processor for interpreting received signals and generating signals to be transmitted over the wireless network based upon at least one environmental management function. A plurality of ports is also provided, each for receiving a plug-in component that provides information to implement a specific environmental management function. The system also includes a user interface operatively associated with the processor and the plurality of ports for adjusting user-controllable parameters. The user-controllable parameters are determined, at least in part, by at least one of the plug-in components when operationally inserted into one of the ports.

### STATEMENT OF RELATED APPLICATION

This application claims the benefit of U.S. Provisional Application No. 60/669,101, filed Apr. 7, 2005, which is incorporated herein by reference in its entirety.

### FIELD OF THE INVENTION

The present invention relates generally to environmental management systems such as security and automation systems, and more particularly to a controller for providing flexible and incremental expandability of environmental management systems.

### BACKGROUND OF THE INVENTION

In residential and commercial environments there are many stand-alone devices and often one or more individual environmental management systems functioning independently. For instance, electronic security systems are relatively common in residential and commercial environments. Individuals and families, in particular, desire a security system that monitors a defined premises and/or environment, to prevent or deter theft, burglary and robbery. In addition, there is a desire to monitor and detect other defined conditions and, in response to a detected condition, generate a warning. These other potentially hazardous conditions or threats include, for example, fire hazards, carbon monoxide and power failure and electricity outages.

A conventional security system for use in a residence, for example, includes one or more keypads with displays and a central control panel, which in some cases is remotely located from the keypads and displays. A number of sensors for detecting various conditions are arranged in the home or premises. In legacy security systems, the sensors are most commonly connected to the control panel by wired means. The sensors may be of various types designed to detect a variety of conditions. More recently, wireless security systems have become available. The sensors are generally relatively simple devices having two operational states represented by a contact that is either in an open or closed state.

In addition to security systems, home automation systems are another type of environmental management system that are becoming more readily available in residences. Home automation systems, or home management systems as they are sometimes called, enable control of lighting, heating and air conditioning, window shades or curtains, pool heaters and filtration systems, lawn sprinklers, ornamental fountains, audio/visual equipment, and other appliances. Home automation systems range from relatively simple systems that control one or a few functions in a home to more elaborate systems that control multiple, disparate features.

In general, a home automation or control system comprises one or more controlled devices, one or more controllers, and a communication link coupling a controller to a controlled device. The controllers may be directly programmable, in which case they include some form of user interface for setting switches, event timing, and the like. Alternatively, the controllers may be indirectly or remotely programmable, in which case a separate user interface may be implemented by a personal computer or the like. Systems may be programmed using either a simple command language or using a graphical user interface that requires a computer with a monitor. These systems are often expensive and require substantial investment by the user in time and energy to install and modify programming. To enter and/or change a program, a user must consult a user's manual or call a programming specialist. Hence, in comparison to some security systems, these systems can be difficult to install and adapt to changing needs. Moreover, they are difficult to expand by adding new controlled devices or new software to add functionality.

Traditionally, the security system market has been quite distinct from the home automation market. For example, not only do most security systems fail to provide the control capabilities offered by home automation systems, their monitoring abilities are also usually quite limited, typically to sensors that are either “on” or “off.” Thus, for instance, few security systems even have the capability to monitor and report something as simple as the ambient temperature of the monitored premises. In part this market segmentation arises from the different demands placed on the two different types of systems. For instance, security systems must be highly reliable and meet stringent regulatory and other requirements, something which is generally not necessary for automation systems. Security system controllers are generally designed to interface with a very limited range of sensors while home automation controllers generally interface with a large number of different devices. Additionally, security system controllers generally offer unidirectional communication between the sensors and controller, whereas automation system controllers more commonly offer bidirectional communication with various devices.

Even within the home automation market itself, there is significant market segmentation because most of the automation control manufacturers address narrow, vertical market segments, and use proprietary interfaces to protect their market. For example, some leading control manufacturers offer systems that focus on heating, ventilation, and air conditioning (HVAC) systems control. These manufacturers have little interest in controlling lighting, entertainment systems, and the like as these markets are entirely foreign to them. Other manufacturers make, for example, home entertainment controllers that integrate various video and audio components, but the primary focus has been to offer integrated control over only their own components. As a result, consumers face an array of control systems that do not interoperate, and that have proprietary interfaces that are difficult to understand and program. That is, the use of multiple platforms generally means that the interfaces are inconsistent with each other in the manner in which controls are accessed, displayed and operate so that a consumer must learn the unique interface features of each system. Hence, as more systems are added, the complexity for the consumer increases significantly as new control interfaces must be added and learned.

Recently, some efforts have been made to provide integrated security and automation systems. In addition to the simplifications that arise from using a single platform, this combination of systems offers enhanced functionality and features that neither provide on their own. For instance, home automation systems may be integrated with a home security system so that when a fire alarm is raised, for example, internal and external lights will be turned on. An example of such a system is Home Automation Inc.'s Omni Automation and Security System, which includes a controller that can support both security and automation needs.

The consumer is thus currently faced with three primary choices when considering installation of security and/or automation systems. The consumer may purchase just a security system, just an automation system or a system such as the Omni Automation and Security System that provides both security and automation. If the consumer purchases either a dedicated security or automation system, future expansion of the system to include the other is limited, thus requiring the purchase of a separate and independent system. On the other hand, if the consumer purchases an integrated security and automation system, he or she may be purchasing a system that is more capable, and hence more expensive, than their current requirements demand.

Accordingly, it would be desirable to provide a system that is flexible, interoperable with a variety of existing or legacy systems, and which allows for incremental or modular expansion to provide additional functionality as desired.

### BRIEF DESCRIPTION OF THE DRAWINGS

FIG. 1 shows an example of a residential security system.

FIG. 2 is a logical diagram of a modular controller.

FIG. 3 is a block diagram representing a hardware view of the modular controller depicted in FIG. 2.

FIG. 4 shows the modular controller of FIGS. 2 and 3 incorporated into the security system shown in FIG. 1.

### DETAILED DESCRIPTION

In general, security and automation systems may be used to provide security and automation to a home, office, or other type of commercial or residential building. In the residential context, the systems establish a home network that controls, coordinates, facilitates, and monitors user-designated activities within the home. The systems may also provide compatibility between external and internal networks, systems, and appliances. As described in more detail below, a controller is provided that is modular in construction to allow easy expansion and customization. The modular controller can be retrofitted for use in existing structures with legacy systems to provide enhanced functionality without the need for drastic remodeling, added wiring, or complicated installation/customization, and can simplify installation, whether performed by the resident or a professional installer. Moreover, the modularity of the controller provides for easy customization for either commercial or residential use. Expansion can be accomplished by adding new plug-in components or modules to the controller. Although the following examples are primarily described with reference to home applications, the described devices and concepts also are applicable for commercial use.

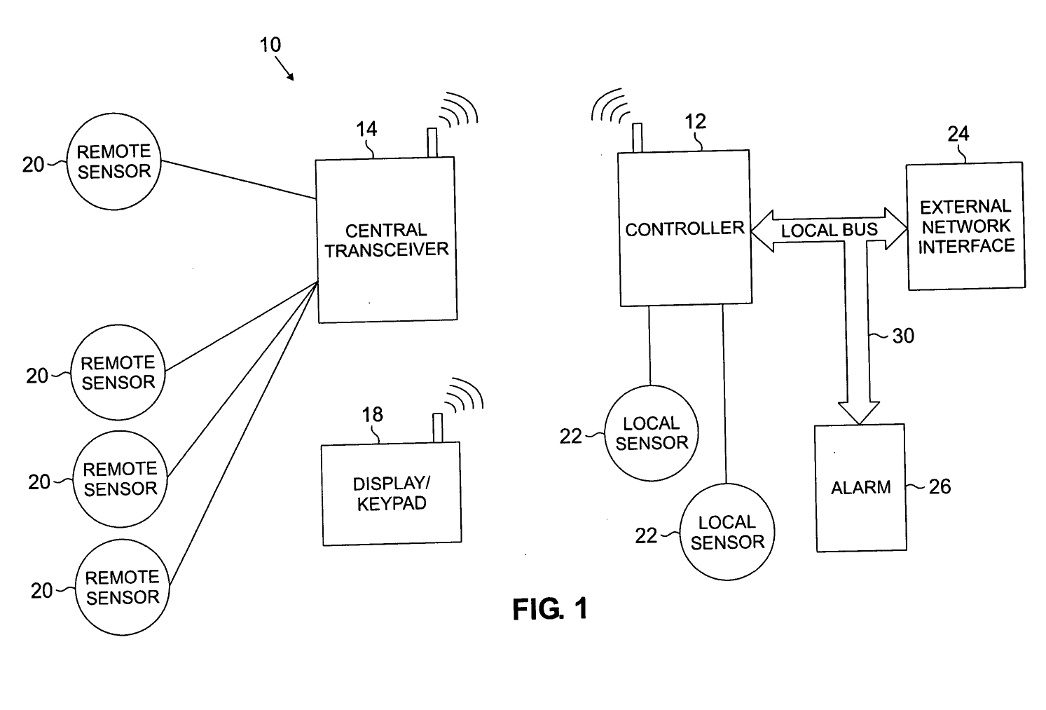

For purposes of illustration the following example will assume that a security system of the type shown in FIG. 1 is already present in a residence and that the resident desires to expand the system to include automation functionality. However, the same principles apply to a situation in which a home automation system is initially present and the resident wishes to expand the system to include security functionality. In other cases the resident may simply desire to expand the capacity of the automation or security system by allowing it, for instance, to monitor, say, 40 sensors instead of merely 20 sensors. Moreover, the security system is assumed to be largely a wireless system in which RF communications is used for all or some of the devices. As shown, the security system 10 comprises a central control unit 12, a central transceiver 14 (which in some cases may be eliminated and replaced by a receiver incorporated in the central control unit 12), a console display/keypad 18, a plurality of remote sensors 20 and local sensors 22, an external network interface 24 and an alarm 26. The remote sensors 20 may wirelessly or hard-wired to the central transceiver 14, which communicates with the central control unit 12 via a wireless protocol. The central control unit 12 also communicates with the console display/keypad 18 over a wireless link. The central control unit 12 is connected to the external network interface 24 (e.g., an autodialer to communicate over the public switched telephone network or a data connection to communicate over the Internet) and the alarm 26 either wirelessly or via a local bus such as local bus 30. The central control unit 12 optionally may also be hardwired to one or more local sensors 22.

Currently available wireless security systems use any of a variety of different communication standards. For example, such systems may use, without limitation, IEEE 802.11 (e.g., 802.11a; 802.11b; 802.11g), IEEE 802.15 (e.g., 802.15.1; 802.15.3, 802.15.4), DECT, PWT, pager, PCS, Wi-Fi, Bluetooth™, cellular, and the like. While the wireless security systems, and hence wireless controllers employed in such systems, may encompass any of these standards, one particularly advantageous network protocol that is currently growing in use is ZigBee™, which is a software layer based on the IEEE standard 802.15.4. Unlike the IEEE 802.11 and Bluetooth standards, ZigBee offers long battery life (measured in months or even years), high reliability, small size, automatic or semi-automatic installation, and low cost. With a relatively low data rate, 802.15.4 compliant devices are expected to be targeted to such cost-sensitive, low data rate markets as industrial sensors, commercial metering, consumer electronics, toys and games, and home automation and security. For these reasons ZigBee may be particularly appropriate for use in both wireless security systems and wireless home automation systems.

ZigBee-compliant products operate in unlicensed bands worldwide, including 2.4 GHz (global), 902 to 928 MHz (Americas), and 868 MHz (Europe). Raw data throughput rates of 250 Kbps can be achieved at 2.4 GHz (16 channels), 40 Kbps at 915 MHz (10 channels), and 20 Kbps at 868 MHz (1 channel). The transmission distance generally ranges from 10 to 75 m, depending on power output and environmental characteristics. Like Wi-Fi, Zigbee uses direct-sequence spread spectrum in the 2.4 GHz band, with offset-quadrature phase-shift keying modulation. Channel width is 2 MHz with a 5 MHz channel spacing. The 868 and 900 MHz bands also use direct-sequence spread spectrum but with binary-phase-shift keying modulation.

Given an installed security system such as described above in connection with FIG. 1, home automation functionality may be provided by the addition of an adjunct, modular controller. As discussed in more detail below, the modular controller may be used not only to extend an installed security or automation system, it may also be used as the foundation of an integrated system that offers security functionality, automation functionality, or both. The functionality may all be deployed in the initial system or it may be added incrementally. That is, the modular controller can be used to overcome the problem that arises when a resident wishes to expand either a security or automation system with capabilities that were not originally provided. Moreover, the security system may even operate in conformance with one wireless standard while the automation system may operate in conformance with a different wireless standard.

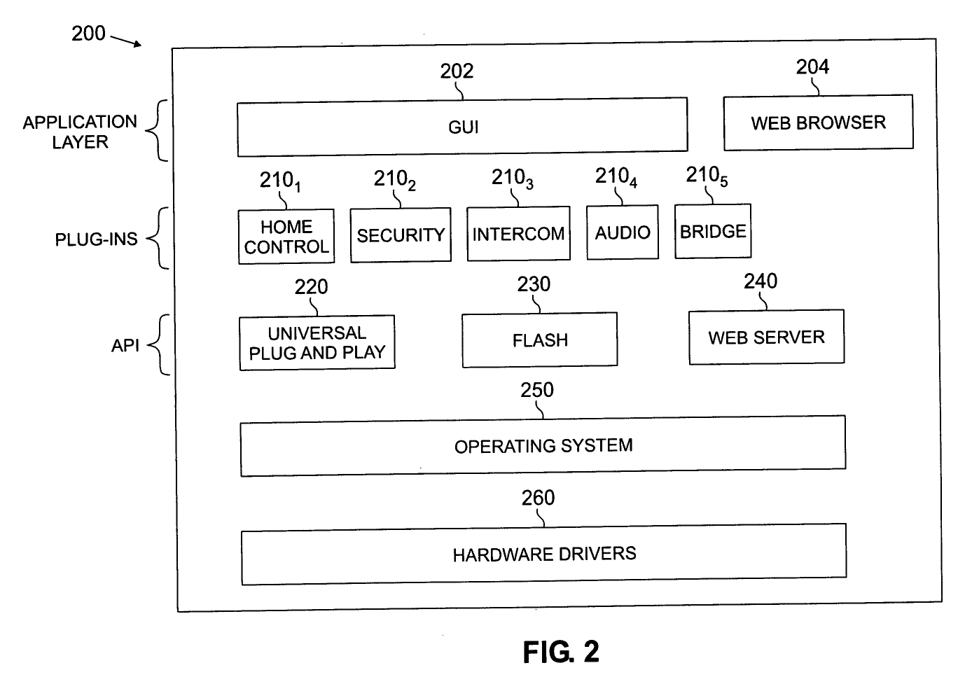

FIG. 2 is a logical diagram of one embodiment of a modular controller 200. Modular or configurable functionality is implemented at the application layer by one or more plug-in components such as plug-ins 210₁-210₅. The plug-in components may be physically implemented as user insertable and removable cards (e.g., flash cards, PCMA cards), modules, and the like. The form factor of the plug-ins may conform to a well-established standard or it may be proprietary. The plug-in components may be implemented on a single integrated circuit, such as an application specific integrated circuit (ASIC). However, the components may also be readily implemented on multiple separate integrated circuits or in software operating on a general purpose processor located in the modular controller 200. The application layer may be a native graphical user interface (GUI) 202 or web browser 204 that are configurable by each of the different plug-in components. Illustrative special purpose plug-in components include a home automation component 210₁, a home security component 210₂, and possibly any of a variety of other components such as an intercom component 210₃ for providing telephony-type services throughout all or part of the premises or an audio component 210₄ for playing audio files (e.g., music) throughout all or part of the premises.

The plug-in components 210₁-210₅ operate in conformance with an application programming interface (API) layer that provides access to services available from the operating system (OS) 250 and augments those services that the OS provides. The API layer may be implemented in a variety of different ways, such as with Universal Plug-and Play protocols and procedures 220, flash processes 230 related to a Macromedia FLASH programming environment, and/or web server products 240.

The API layer, via the OS layer 250, controls the driver layer 260. The driver layer 260, in turn, interfaces with the various hardware components of the controller such as a microprocessor, hardware communication interfaces to sensors, actuators, and the like. Drivers may be added or removed as needed to support additional or updated functionality.

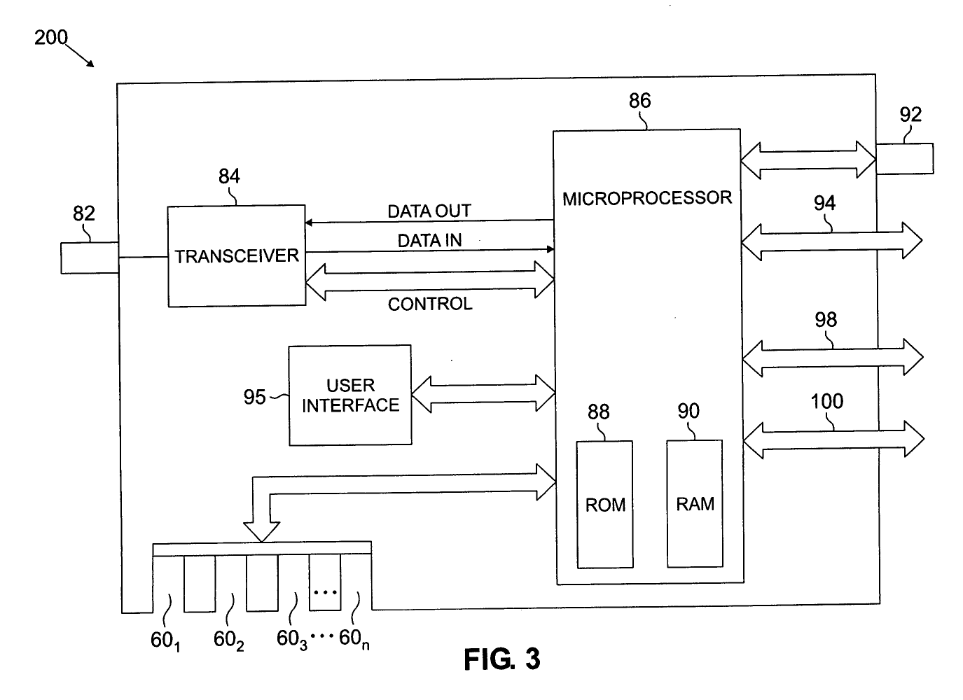

FIG. 3 is a block diagram representing a hardware view of the modular controller 200 depicted in FIG. 2. The modular controller 200 includes an antenna port 82, RF front-end transceiver 84, one or more plug-in ports 60₁, 60₂, 60₃, . . . 60ₙ, microprocessor 86 having ROM 88 and RAM 90, programming port 92, and local bus 94 (corresponding to local bus 30 in FIG. 1). Local bus 94 may also be used to communicate with any local sensors, actuators, or networked devices that may be employed. RF front-end transceiver 84 may be compliant with one or more wireless formats. In some cases the front-end transceiver 84 may be compliant with the ZigBee standard as well as with at least one other wireless standard commonly used in legacy security or automation systems (e.g., IEEE 802.11). In other cases the transceiver 84 may be able to operate in conformance with a number of different wireless standards with the use of appropriate plug-in components. If employed, local bus 94 may include, for example, one or more analog-to-digital inputs, one or more digital-to-analog outputs, one or more UART ports, one or more Serial Peripheral Interface (SPI) and/or one or more digital I/O lines (not shown). The network controller may also include RAM port 98 and ROM port 100 (or a single port for both) for, among other things, upgrading software residing in the microprocessor 86 (as opposed to upgrades performed by replacement of plug-in components, discussed below). User interface 95 (e.g., a keypad/display unit) functions at the application level of FIG. 2 and allows control of the various user-adjustable parameters of the modular controller 200.

The modular controller 200 provides a consumer with a great degree of flexibility when initially purchasing a system. For example, if the consumer is in immediate need of a security system, the consumer can purchase the modular controller 200 with only the security plug-in 2102 (along with the associated sensors and the like). If at a later time the consumer wishes to install an automation system, the consumer can simply purchase the home automation plug-in 210, (along with the associated monitors, actuators and the like). In this way the consumer only needs to purchase as much equipment as is necessary to serve his or her immediate needs, without limiting the future expandability of the system.

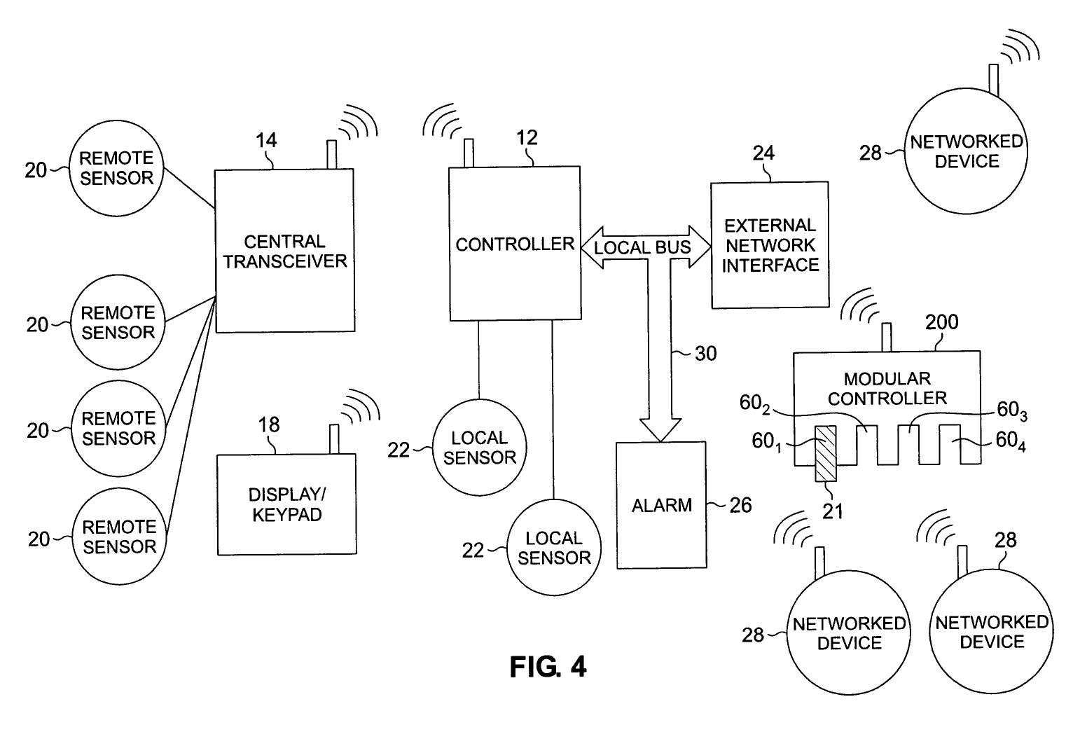

The modular controller 200 also provides the consumer with a number of different upgrade paths, depending on the equipment that is already in place. For instance, if the legacy equipment includes the modular controller itself, upgrading to provide automation features is a simple matter of purchasing additional plug-in components along with any associated peripheral equipment. On the other hand, if the legacy system is a dedicated independent security system (or automation system) of a conventional type, the modular controller 200 can be incorporated into the legacy system with the use of an additional plug-in component that is configured to allow the modular controller to interoperate with the legacy controller. In other cases the legacy equipment can be upgraded to provide more capacity so that the system can monitor more sensors (in the case of a security system) or control more devices (in the case of an automation system). An example of such an arrangement is shown in FIG. 4, in which modular controller 200 has been incorporated into the security system shown in FIG. 1. In FIGS. 1-4 like elements are denoted by like reference numerals. Also shown in FIG. 4 are networked devices 28 that are in communication with and under the control of the modulator controller 200. Such networked devices include, without limitation, networked appliances such as coffee makers, ovens, lights, television and stereo units, media centers.

Referring to FIG. 4, modular controller 200 includes a plug-in 210₅, referred to herein as a bridge plug-in, which allows modular controller 200 to interoperate with legacy controller 12. Bridge plug-in 2105 may provide two levels of interoperability. On the physical level, bridge plug-in 210₅ may convert between a communication format employed by the legacy security system and the native communication format employed by the modular controller 200 for the system that is to be added. For instance, the security system may use a low power, low bandwidth format such as IEEE 802.15.4 while the automation system may use another wireless local access network (WLAN) format such as IEEE 802.11, a cellular based communication format (e.g., CDMA, TDMA, GSM), and the like. In addition to physical interoperability, bridge plug-in 2105 may also provide application level interoperability so that legacy controller 12 and modular controller 200 can use and respond to information received from one another. For example, if a signal is generated by a security sensor 20 indicating that a door or window has been opened, the legacy system will use that signal to activate the alarm 26 and notify the appropriate agency or entity using external network interface 24. Likewise, modular controller 200 may use that same signal from the security sensor to turn on lights or activate a camera or other devices under control of the modular controller 200. Depending on the level of sophistication of the bridge plug-in 201₅, the modular controller 200 may also be able to activate and deactivate features of the legacy security system or communicate information through the legacy security controller 12. For instance, if in response to a security sensor 20 the modular controller 200 activates a camera, the data from that camera may be forwarded from the modular controller 200 to the legacy security controller 12, which may in turn transmit the data using external network interface 24 to the same agency or entity that is notified when a security sensor indicates unauthorized entry.

The manufacturer of the modular controller 200 may also manufacture a variety of different bridge plug-ins for various legacy security systems to enhance its flexibility. Alternatively, or additionally, the manufacturer of the legacy security system or even a third party may provide bridge plug-in components for the modular controller 200. In this way the flexibility and number of compatible legacy systems with which the controller operates can be increased still further.

A number of other benefits arise from the use of a modular controller as described above. For example, the manufacturer may occasionally upgrade one or more the plug-in components to provide advanced features not previously available or even contemplated. For example, if lighting were eventually to become available in which the user could control not only its intensity, but also its color, it would be desirable if in addition to simply turning the lighting on and off and adjusting the dimming level, the automation system could also control the color of the lighting. The enhanced functionality can be readily achieved by providing the user with an upgraded automation plug-in module (e.g., module 210,) that expands the message set defining control of lighting from one that refers only to intensity to one that specifies color and intensity.

Although various embodiments are specifically illustrated and described herein, it will be appreciated that modifications and variations are covered by the above teachings and are within the purview of the appended claims without departing from the spirit and intended scope of the invention. For example, while modular functionality has been described in terms of the provision of plug-in modules, this same functionality can be provided by software components or modules that are downloaded directly to the controller without the need to add any additional hardware components to the controller. Moreover, while the environmental management system and controller have been described in terms of a wireless system and controller, in some cases the environmental management system and controller may operate in a wired manner.

1. A controller for an environmental management system, comprising:
a transceiver for transmitting signals to and receiving signals from at least one environmental sensor or actuator over a network;
a processor for interpreting received signals and generating signals to be transmitted over the wireless network based upon at least one environmental management function;
a plurality of ports each for receiving a plug-in component that provides information to implement a specific environmental management function;
a user interface operatively associated with the processor and the plurality of ports for adjusting user-controllable parameters, said user-controllable parameters being determined, at least in part, by at least one of the plug-in components when operationally inserted into one of the ports.

2. The controller of claim 1 further comprising a plurality of plug-in components selectively insertable in and removable from each of the plurality of ports, each of the plug-in components being configured to implement, in association with the processor, a specific environmental management function.

3. The controller of claim 1 wherein said transceiver and said network are in communication in a wireless manner.

4. The controller of claim 1 wherein one of the plurality of plug-in components is configured to implement functionality associated with an environmental security system.

5. The controller of claim 2 wherein one of the plurality of plug-in components is configured to implement functionality associated with an environmental automation system.

6. The controller of claim 2 wherein another of the plurality of plug-in components is configured to enhance capacity of the environmental management system.

7. The controller of claim 1 further comprising a bridge plug-in component configured to facilitate interoperability with a legacy environmental management system.

8. The controller of claim 7 wherein said interoperability facilitated by the bridge plug-in component includes physical layer and application layer interoperability.

9. A method for upgrading a pre-existing environmental management system that performs a specific environmental management function, comprising:
providing a modular controller for an environmental management system that performs a second environmental management function, said modular controller having a plurality of ports each for receiving a plug-in component; and
inserting at least one plug-in component into one of the plurality of ports, said plug-in component being configured to provide at least application level interoperability between the pre-existing environmental management system and the modular controller so that wireless signals communicated therebetween are correctly interpreted.

10. The method of claim 9 further comprising the step of inserting a second plug-in component into one of the plurality of ports for configuring the modular controller to perform the second environmental management function.

11. The method of claim 9 wherein said modular controller is a wireless controller.

12. The method of claim 10 wherein one of the plurality of the plug-in components is configured to implement functionality associated with an environmental security system.

13. The method of claim 10 wherein one of the plurality of plug-in components is configured to implement functionality associated with an environmental automation system.

14. The method of claim 9 wherein one of the plurality of plug-in components is configured to enhance capacity of the environmental management system.

15. The method of claim 9 further comprising the step of inserting a bridge plug-in component configured to facilitate interoperability with a legacy environmental management system.

16. The method of claim 15 wherein said interoperability facilitated by the bridge plug-in component includes physical layer and application layer interoperability.
